(19) United States
(12) Patent Application Publication
(10) Pub. No.: US 2025/0079509 A1
(43) Pub. Date: Mar. 6, 2025

(54) SOLID ELECTROLYTE, ANODE MIXTURE, BATTERY, AND METHOD FOR PRODUCING BATTERY

(71) Applicant: TOYOTA JIDOSHA KABUSHIKI KAISHA, Toyota-shi (JP)

(72) Inventor: Toru KIDOSAKI, Miyoshi-shi (JP)

(73) Assignee: TOYOTA JIDOSHA KABUSHIKI KAISHA, Toyota-shi (JP)

(21) Appl. No.: 18/811,473

(22) Filed: Aug. 21, 2024

(30) Foreign Application Priority Data
Sep. 5, 2023 (JP) 2023-143809

(51) Int. Cl. H01M 10/0562; H01M 4/02; H01M 4/38

(52) U.S. Cl. CPC H01M 10/0562; H01M 4/386; H01M 2004/027; H01M 2300/0068

(57) ABSTRACT

A main object of the present disclosure is to provide a solid electrolyte capable of inhibiting increase of battery resistance. The present disclosure achieves the object by providing a solid electrolyte, wherein a breaking energy in a filling rate of 100% is more than 21.4*10³ kJ/m³, when formed into a pellet having a length of 5 mm in an X axis direction, a length of 20 mm in a Y axis direction, and a length of 1 mm in a Z axis direction.

### TECHNICAL FIELD

The present disclosure relates to a solid electrolyte, an anode mixture containing the solid electrolyte, a battery, and a method for producing a battery.

### BACKGROUND ART

A battery usually includes an anode current collector, an anode active material layer, an electrolyte layer, a cathode active material layer and a cathode current collector.

For example, Patent Literature 1 discloses that an all solid lithium battery is produced using an anode slurry containing a silicon-based active material, a sulfide solid electrolyte, a styrene butadiene rubber, and a dispersion medium.

### CITATION LIST

### Patent Literature

Patent Literature 1: Japanese Patent Application Laid-Open (JP-A) No. 2019-125468

### SUMMARY OF DISCLOSURE

### Technical Problem

In batteries, there is a risk that the electrode layer expands and contracts due to charge and discharge, and when charge and discharge are repeated, there is a risk that cracks may be generated in the electrode layer and the solid electrolyte layer, and peel-off of the electrode layer and the solid electrolyte layer may occur. When the cracks and the peel-off occur, ion conduction path and electron conduction path are cut out, and there is a risk that the battery resistance may increase. For this reason, from the viewpoint of improving the battery performance, it is required to inhibit the cracks and peel-off so as to inhibit the increase of the battery resistance.

The present disclosure has been made in view of the above circumstances and a main object thereof is to provide a solid electrolyte capable of inhibiting increase of battery resistance.

### Solution to Problem

[1]

A solid electrolyte, wherein a breaking energy in a filling rate of 100% is more than 21.4*10³ kJ/m³, when formed into a pellet having a length of 5 mm in an X axis direction, a length of 20 mm in a Y axis direction, and a length of 1 mm in a Z axis direction.

[2]

The solid electrolyte according to [1], wherein the breaking energy is 34.2*10³ kJ/m³ or more.

[3]

The solid electrolyte according to [1] or [2], wherein the breaking energy is 75.0*10³ kJ/m³ or less.

[4]

The solid electrolyte according to any one of [1] to [3], wherein the solid electrolyte is a sulfide solid electrolyte.

[5]

The solid electrolyte according to [4], wherein the sulfide solid electrolyte contains a Li element, an A element (A is at least one kind of P, As, Sb, Si, Ge, Sn, B, Al, Ga, and In), and a S element.

[6]

The solid electrolyte according to [4] or [5], wherein the sulfide solid electrolyte contains a Li element, a P element, and a S element.

[7]

An anode mixture comprising an anode active material and a solid electrolyte, wherein the solid electrolyte is the solid electrolyte according to any one of [1] to [6].

[8]

The anode mixture according to [7], wherein the anode active material is a Si-based active material.

[9]

A battery comprising a cathode active material layer, an anode active material layer, and an electrolyte layer arranged between the cathode active material layer and the anode active material layer, wherein at least one of the cathode active material layer, the anode active material layer, and the electrolyte layer contains the solid electrolyte according to any one of [1] to [6].

[10]

A method for producing a battery including a cathode active material layer, an anode active material layer, and an electrolyte layer arranged between the cathode active material layer and the anode active material layer, the method comprising: an anode active material layer forming step of forming the anode active material layer using an anode mixture containing an anode active material and an electrolyte, wherein the electrolyte is the solid electrolyte according to any one of [1] to [6].

### Advantageous Effects of Disclosure

The present disclosure exhibits an effect of inhibiting increase of battery resistance.

### BRIEF DESCRIPTION OF DRAWINGS

FIG. 1 is a schematic perspective view exemplifying the pellet in the present disclosure.

FIG. 2 is a schematic cross-sectional view exemplifying the battery in the present disclosure.

FIG. 3 is a graph showing a relation of the breaking energy and the battery resistance in Examples and Comparative Examples.

### DESCRIPTION OF EMBODIMENTS

The solid electrolyte, the anode mixture containing the solid electrolyte, the battery, and the method for producing the battery in the present disclosure will be hereinafter explained in details.

### A. Solid Electrolyte

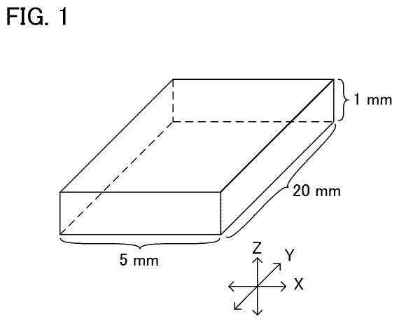

As shown in FIG. 1, in the solid electrolyte in the present disclosure, a breaking energy in a filling rate of 100% is more than 21.4*10³ kJ/m³, when formed into a pellet having a length of 5 mm in an X axis direction, a length of 20 mm in a Y axis direction, and a length of 1 mm in a Z axis direction.

According to the present disclosure, since the breaking energy is more than 21.4*10³ kJ/m³, when formed into a pellet having the specified size, it is considered that the cracks and peel-off of the electrode layer and the solid electrolyte can be inhibited even when the electrode layer (active material layers) expands and contracts due to charge and discharge of the battery. As a result, excellent ion conduction path and electron conduction path can be maintained, and thereby increase of battery resistance can be inhibited.

The breaking energy in a filling rate (filling rate of the solid electrolyte in the pellet) of 100% may be 34.2*10³ kJ/m³ or more, and may be 51.3*10³ kJ/m³ or more. Meanwhile, the breaking energy is, for example, 75.0*10³ kJ/m³ or less, may be 70.0*10³ kJ/m³ or less, and may be 67.9*10³ kJ/m³ or less.

The breaking energy can be measured by a method described in Examples.

It is preferable that the crystallinity of the solid electrolyte is low. As later described in Examples, excellent breaking energy was shown in the solid electrolyte of which burning temperature during the production of the solid electrolyte was comparatively low, that is, the solid electrolyte with comparatively low crystallinity. This is presumably because the crystallinity of the solid electrolyte affected the strength of interface bonding of solid electrolytes in the pellet.

The crystallinity of the solid electrolyte is, for example, 80% or less, may be 70% or less, may be 60% or less, and may be 50% or less. Meanwhile, the crystallinity is, for example, 5% or more, may be 10% or more, and may be 30% or more. The crystallinity may be a value obtained from an X-ray diffraction method. Also, the crystallinity may be a value obtained from a differential scanning calorimetry (DSC).

The Li ion conductivity of the solid electrolyte is preferably high. The Li ion conductivity of the solid electrolyte at 25° C. is, for example, 1*10-4 S/cm or more, and is preferably 1*10-3 S/cm or more. The insulation properties of the solid electrolyte are preferably high. The electron conductivity of the solid electrolyte at 25° C. is, for example, 10⁻⁶ S/cm or less, may be 10⁻⁸ S/cm or less, and may be 10⁻¹⁰ S/cm or less. Also, examples of the shape of the solid electrolyte may include a granular shape. The average particle size (D₅₀) of the solid electrolyte is, for example, 0.1 μm or more and 50 μm or less. Incidentally, the average particle size (D₅₀) refers to a particle size of 50% accumulation in a particle size distribution in a volume basis by a laser diffraction particle distribution measurement device.

Examples of the solid electrolyte may include an inorganic solid electrolyte such as a sulfide solid electrolyte, an oxide solid electrolyte, and a nitride solid electrolyte; and an organic solid electrolyte such as a polymer electrolyte. Among these, the sulfide solid electrolyte is preferable. The reason therefor is its high Li conductivity.

The sulfide solid electrolyte preferably contains sulfur (S) as a main component of the anion element. The oxide solid electrolyte preferably contains oxygen (O) as a main component of the anion element. The nitride solid electrolyte preferably contains nitrogen (N) as a main component of the anion element.

It is preferable that the sulfide solid electrolyte contains, for example, a Li element, an A element (A is at least one kind of P, As, Sb, Si, Ge, Sn, B, Al, Ga, and In), and a S element. Also, the sulfide solid electrolyte may further contain at least one of an O element and a halogen element. Examples of the halogen element may include a F element, a Cl element, a Br element, and an I element.

The sulfide solid electrolyte preferably includes an anion structure of an ortho composition (such as PS₄³⁻ structure, SiS₄⁴⁻ structure, GeS₄⁴⁻ structure, AlS₃³⁻ structure, or BS₃³⁻ structure) as the main component of the anion structure. The reason therefor is that chemical stability is high. The proportion of the anion structure of the ortho composition with respect to all the anion structures in the sulfide solid electrolyte is, for example, 70 mol % or more and may be 90 mol % or more.

The sulfide solid electrolyte may include a crystal phase. Examples of the crystal phase may include a Thio-LISICON type crystal phase, a LGPS type crystal phase, and an argyrodite type crystal phase.

There are no particular limitations on the composition of the sulfide solid electrolyte, and examples thereof may include xLi₂S·(100−x)P₂S₅(70≤x≤80), and yLiI·zLiBr·(100−y−z) (xLi₂S·(1−x)P₂S₅) (0.7≤x≤0.8, 0≤y≤30, 0≤z 30).

Examples of the oxide solid electrolyte may include a Perovskite type solid electrolyte such as (Li, La) TiO₃. Examples of the nitride solid electrolyte may include Li₃N, and Li₃N—LiI—LiOH.

Examples of the polymer electrolyte may include a polyethylene oxide (PEO), and a polypropylene oxide (PPO).

### B. Anode Mixture

An anode mixture includes an anode active material and the above described solid electrolyte. The solid electrolyte is as described in “A. Solid electrolyte”.

The anode active material is not particularly limited, and examples thereof may include a Li-based active material such as a metal lithium and a lithium alloy; a carbon-based active material such as graphite, hard carbon and soft carbon; an oxide-based active material such as lithium titanate; and a Si-based active material.

Particularly when the volume expansion rate of the anode active material is large, the effect of inhibiting increase of battery resistance of the present disclosure can be more enjoyed. The volume expansion rate of the anode active material is, for example, 120% or more and 300% or less. Examples of the active material with high volume expansion rate may include a Si-based active material.

The Si-based active material is an active material containing a Si element. Examples of the Si-based active material may include a simple substance Si, a Si alloy and a Si oxide. The Si alloy preferably contains a Si element as a main component. The proportion of the Si in the Si alloy is, for example, 50 mol % or more, may be 70 mol % or more, and may be 90 mol % or more. Examples of the Si alloy may include a Si-Al-based alloy, a Si-Sn-based alloy, a Si-In-based alloy, a Si-Ag-based alloy, a Si-Pb-based alloy, a Si-Sb-based alloy, a Si-Bi-based alloy, a Si-Mg-based alloy, a Si-Ca-based alloy, a Si-Ge-based alloy, and a Si-Pb-based alloy. The Si alloy may be a two component alloy, and may be a multi component alloy of three components or more. Examples of the Si oxide may include SiO.

Examples of the shape of the anode active material may include a granular shape. The average particle size (D₅₀) of the anode active material is, for example, 10 nm or more, and may be 100 nm or more. Meanwhile, the average particle size (D₅₀) of the anode active material is, for example, 50 μm or less, and may be 20 μm or less. The average particle side (D₅₀) is as described above.

The anode mixture may contain at least one of a conductive auxiliary material and a binder, as required. Examples of the conductive auxiliary material may include a carbon material. Examples of the carbon material may include a particulate carbon material such as acetylene black (AB) and Ketjen black (KB), and a fiber carbon material such as carbon fiber, carbon nanotube (CNT), and carbon nanofiber (CNF).

Examples of the binder may include a rubber-based binder such as butadiene rubber (BR), acrylate butadiene rubber (ABR) and styrene butadiene rubber (SBR); and a fluorine-containing binder such as polyvinylidene fluoride (PVDF) and polytetra fluoroethylene (PTFE).

The anode mixture in the present disclosure may contain liquid-based electrolyte (liquid electrolyte) as the electrolyte. When the anode mixture contains the liquid electrolyte, the proportion of the liquid electrolyte with respect to all the electrolytes is, for example, 10 weight % or less. Examples of the liquid electrolyte may include conventionally known liquid electrolytes that can be used in lithium ion batteries.

### C. Battery

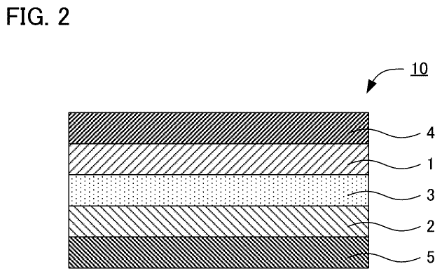

FIG. 2 is a schematic cross-sectional view exemplifying the battery in the present disclosure. Battery 10 shown in FIG. 2 includes cathode active material layer 1, anode active material layer 2, and electrolyte layer 3 arranged between the cathode active material layer 1 and the anode active material layer 2. In the battery of the present disclosure, at least one of the cathode active material layer, the anode active material layer, and the electrolyte layer contains the above described solid electrolyte. Also, as shown in FIG. 2, the battery 10 usually includes cathode current collector 4 for collecting electrons of the cathode active material layer 1, and anode current collector 5 for collecting electrons of the anode active material layer 2.

Here, the battery in the present disclosure may be a battery that contains both a solid electrolyte and an electrolyte solution (liquid electrolyte) as the electrolyte. In the battery that contains both the solid electrolyte and the electrolyte solution as the electrolyte, the proportion of the liquid electrolyte with respect to all the electrolytes is, for example, 10 weight % or less. The liquid electrolyte is as described in “B. Anode mixture”. Also, the battery in the present disclosure may be a so-called all solid state battery that contains just the solid electrolyte as the electrolyte.

### 1. Cathode Active Material Layer

The cathode active material layer contains at least a cathode active material. Also, the cathode active material layer may contain at least one of a conductive auxiliary material, a binder, and an electrolyte, as required. The conductive auxiliary material and the binder are in the same contents as those described in “B. Anode mixture”. Incidentally, the cathode active material layer preferably contains the above described solid electrolyte as the electrolyte.

Examples of the cathode active material may include an oxide active material. Examples of the oxide active material may include a rock salt bed type active material such as LiNi_{1/3}Co_{1/3}Mn_{1/3}O₂; a spinel type active material such as LiMn₂O₄; and an olivine type active material such as LiFePO₄. Also, as the cathode active material, sulfur (S) may be used. Examples of the shape of the cathode active material may include a granular shape.

There are no particular limitations on the thickness of the cathode active material layer, and for example, it is 0.1 μm or more and 1000 μm or less.

### 2. Anode Active Material Layer

The anode active material layer contains at least an anode active material. Also, the anode active material layer may contain at least one of a conductive auxiliary material, a binder, and an electrolyte, as required. In particular, the anode active material layer in the present disclosure preferably contains the above described anode mixture.

There are no particular limitations on the thickness of the anode active material layer, and for example, it is 0.1 μm or more and 1000 μm or less.

### 3. Electrolyte Layer

The electrolyte layer contains at least an electrolyte. In particular, the electrolyte layer preferably contains the above described solid electrolyte as the electrolyte. Also, the electrolyte layer may contain a binder and a liquid electrolyte as required. The binder is as described above. The thickness of the electrolyte layer is not particularly limited, and for example, it is 0.1 μm or more and 1000 μm or less.

### 4. Cathode Current Collector and Anode Current Collector

Examples of the material for the cathode current collector may include a metal such as aluminum, SUS, and nickel. Examples of the material for the anode current collector may include a metal such as copper, SUS, and nickel. Examples of the shape of the cathode current collector and the anode current collector may include a foil shape and a mesh shape.

### 5. Battery

The battery in the present disclosure may include an outer package for storing the above described members. Examples of the outer package may include a laminate type outer package and a case type outer package. Also, the battery in the present disclosure may include a restraining jig that applies a restraining pressure in the thickness direction to the above described members. As the restraining jig, known jigs may be used. The restraining pressure is, for example, 0.1 MPa or more and 50 MPa or less, and may be 1 MPa or more and 20 MPa or less.

The kind of the battery in the present disclosure is not particularly limited, but is typically a lithium ion secondary battery. The application of the battery is not particularly limited, and examples thereof may include a power source for vehicles such as hybrid electric vehicles (HEV), plug-in hybrid electric vehicles (PHEV), battery electric vehicles (BEV), gasoline-fueled automobiles and diesel powered automobiles. In particular, it is preferably used as a power source for driving hybrid electric vehicles (HEV), plug-in hybrid electric vehicles (PHEV), and battery electric vehicles (BEV). Also, the battery in the present disclosure may be used as a power source for moving bodies other than vehicles (such as rail road transportation, vessel and airplane), and may be used as a power source for electronic products such as information processing equipment.

### D. Method for Producing Battery

The present disclosure can also provide a method for producing a battery including a cathode active material layer, an anode active material layer, and an electrolyte layer arranged between the cathode active material layer and the anode active material layer, the method including: an anode active material layer forming step of forming the anode active material layer using an anode mixture containing an anode active material and an electrolyte, wherein the electrolyte is the above described solid electrolyte.

### 1. Anode Active Material Layer Forming Step

An anode active material layer forming step is a step of forming the anode active material layer using an anode mixture containing an anode active material and an electrolyte. In particular, the above described solid electrolyte is used as the electrolyte.

The anode active material, the electrolyte, and the anode mixture are as described in “B. Anode mixture”. The anode active material layer can be formed by, for example, pasting an anode slurry containing the anode mixture and a dispersion medium on an anode current collector, and drying thereof. The anode active material layer is as described in “C. Battery”.

### 2. Other Steps

The method for producing the battery in the present disclosure may include a cathode active material layer forming step, an electrolyte layer forming step, and a layered body forming step of forming a layered body that includes layers in the order of a cathode active material layer, an electrolyte layer and an anode active material layer. These may be conventionally known methods in the battery field. The cathode active material layer and the electrolyte layer are as described in “C. Battery”.

### 3. Battery

The Battery is in the same contents as those described in “C. Battery”; thus, the descriptions are omitted.

Incidentally, the present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### EXAMPLES

### Example 1

### <Production of Sulfide Solid Electrolyte>

A raw material composition was obtained by mixing Li₂S, P₂S₅, LiI and LiBr. The raw material composition and tetrahydrofuran that is 20 times of the raw material composition in the mass ratio were put into a container made of glass, and agitated at 25° C. for 72 hours. After that, a sediment was collected as a precursor of a sulfide solid electrolyte. The collected precursor was dried at 25° C. under an argon atmosphere, and then burned at 100° C. for 1 hour under an atmospheric pressure. Obtained burned body was vacuum-sealed in a quartz tube, and the quartz tube was placed in a muffle furnace, and burned at 160° C. for 5 hours. Thereby, a sulfide solid electrolyte (Li₂S-P₂S₅-based sulfide solid electrolyte including LiBr and LiI) was obtained.

### Examples 2 to 4 and Comparative Examples 1 to 3

A sulfide solid electrolyte was respectively produced in the same manner as in Example 1, except that the burning temperature and the burning time in the muffle furnace were respectively changed to the contents shown in Table 1.

### Evaluation

### <Measurement of Breaking Energy>

The sulfide solid electrolytes produced in Examples 1 to 4 and Comparative Examples 1 to 3 were respectively weighed. They were respectively compressed to form pellet as shown in FIG. 1. A bending test was conducted for the obtained pellets using TENSIRON (from A&D Company, Limited) The condition for the bending test was compression mode of TENSIRON at 0.05 mm/min. The breaking energy was calculated by integrating a stress/bending curve line formed based on the stress (bending stress) and the distortion (bending distortion) obtained from the bending test. The results are shown in Table 1. The stress was calculated from the below formula (1), and the distortion was calculated from the below formula (2).

$$\begin{matrix}[ Formula 1 ] & \\ σ = \frac{3 F L}{2 b {h}^{2}} & ( 1 )\end{matrix}$$

In the formula (1), σ represents the bending stress (MPa), b represents the width (5 mm) of the pellet, h represents the thickness (1 mm) of the pellet, F represents the stress (N), and L represents the span (18.5 mm).

$$\begin{matrix}[ Formula 2 ] & \\ {ε}_{i} = \frac{6 h s}{{L}^{2}} & ( 2 )\end{matrix}$$

In the formula (2), ci represents the bending distortion (%), h represents the thickness (1 mm) of the pellet, s represents the deflection (mm), and L represents the span (18.5 mm).

Here, the breaking energy shown in Table 1 is respectively the breaking energy of the pellet of which filling rate of the sulfide solid electrolyte was 100%, obtained based on the calibration curve. The calibration curve regarding the filling rate and the breaking energy was formed by producing three pellets using different pressures (three pellets with different filing rates) using each sulfide solid electrolyte, and conducting the bending test to the three pellets.

### <Measurement of Battery Resistance>

An all solid state battery was respectively produced as below using the above described sulfide solid electrolyte in an anode active material layer.

Incidentally, the designed capacity of the all solid state battery was 0.3 Ah.

To a Filmix container, 18.6 g of an anode active material (simple substance of Si), 8.69 g of the sulfide solid electrolyte, a solution including styrene butadiene rubber that is a binder (binder concentration in the solution was 5 mass % relative to whole solution), and a solvent (diisobutyl ketone) were added. Thereby, a raw material composition for anode of which solid concentration was 43 mass % was obtained. The raw material composition was kneaded using a kneading device (Filmix) to obtain an electrode composition for anode. A PC wheel for high shearing was used for Filmix. The electrode composition was pasted in a film shape on a surface of an anode current collector (nickel foil) by a blade coating method using an applicator, and the film shaped electrode composition was heated at 100° C. for 30 minutes. Thereby, an anode including an anode current collector and an anode active material layer was obtained.

In a Filmix container, 80.0 g of a cathode active material (LiNi_{1/3}Co_{1/3}Mn_{1/3}O₂), 9.51 g of a Li₂S-P₂S₅-based sulfide solid electrolyte, and 2.5 g of a conductive auxiliary material (VGCF) were gathered. After that, 32.21 g of a solution including styrene butadiene rubber that is a binder (binder concentration in the solution was 5 mass % relative to whole solution) and a solvent (tetralin) were added to the Filmix container. Thereby, a raw material composition for cathode of which solid concentration was 69 mass % was obtained. The raw material composition was kneaded using a kneading device (Filmix) to obtain an electrode composition for cathode. The electrode composition was pasted in a film shape on a surface of a cathode current collector (aluminum foil) by a blade coating method using an applicator, and the film shaped electrode composition was heated at 100° C. for 30 minutes. Thereby, a cathode including a cathode current collector and a cathode active material layer was obtained.

The amount of 40 g of a Li₂S-P₂S₅-based sulfide solid electrolyte, 8.00 g of a solution including acrylate butadiene rubber and hexane (concentration of acrylate butadiene rubber in the solution was 5 mass % relative to whole solution), 25.62 g of heptane, and 8.00 g of dibutyl ether were mixed, and kneaded by an ultrasonic homogenizer. Thereby, a solid electrolyte layer composition was obtained. The solid electrolyte layer composition was pasted in a film shape on a surface of an aluminum foil by a blade coating method using an applicator, and the film shaped solid electrolyte layer composition was heated at 100° C. for 30 minutes. Thereby, a transfer member including a substrate (aluminum foil) and a solid electrolyte layer was obtained.

The anode and the transfer member were overlapped so that the anode active material layer and the solid electrolyte layer faced to each other, and then pressed at 20 kN. After that, the aluminum foil was peeled off to transfer the solid electrolyte layer on the anode active material layer. Then, the cathode was overlapped so that the solid electrolyte layer and the cathode active material layer faced to each other, and then pressed at 20 kN. Thereby, a layered body including layers in the order of the anode, the solid electrolyte layer, and the cathode was obtained. The layered body was condensed at 4 ton/cm, and laminate-sealed to produce an all solid state battery. The produced battery was restrained at 5 MPa using a restraining jig.

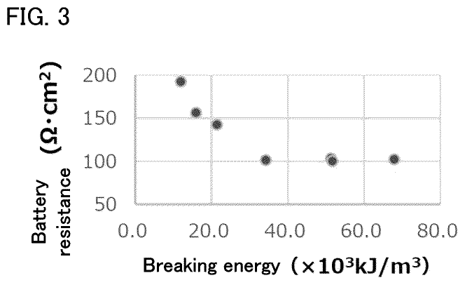

A charge and discharge test was respectively conducted to the obtained all solid state batteries. The conditions of the charge and discharge test were CCCV charge and discharge with upper limit voltage 4.55 V and lower limit voltage 2.5 V, at 0.1 C, and 1000 cycles. The battery resistance after 1000 cycles was respectively measured. The results are shown in Table 1. Also, the relation of the breaking energy and the battery resistance is shown in FIG. 3.

TABLE 1

| | Burning | Burning | Breaking | Battery |
|---|---|---|---|---|
| | temperature | time | energy | resistance |
| | (° C.) | (h) | *10³ (kJ/m³) | (Ω · cm²) |
| Example 1 | 160 | 5 | 67.9 | 102 |
| Example 2 | 170 | 5 | 51.3 | 103 |
| Example 3 | 180 | 5 | 51.7 | 100 |
| Example 4 | 200 | 5 | 34.2 | 101 |
| Comp. Ex. 1 | 550 | 5 | 21.4 | 142 |
| Comp. Ex. 2 | 600 | 5 | 15.9 | 156 |
| Comp. Ex. 3 | 700 | 5 | 11.9 | 192 |

As shown in Table 1 and FIG. 3, the breaking energy of Examples 1 to 4 was respectively remarkably larger compared with Comparative Examples 1 to 3. This is presumably because the solid electrolytes in Examples were produced by burning at comparatively low temperature, and thus the crystallinity was low and interface bond of solid electrolytes was strong. Also, in batteries (batteries of Examples 1 to 4) using the solid electrolyte with large breaking energy in the anode active material layer, it is presumed that the battery resistance was low since cracks and peel-off of the anode active material layer were inhibited. In this manner, it was confirmed that the solid electrolyte in the present disclosure inhibited the increase of battery resistance.

### REFERENCE SINGS LIST

1 cathode active material layer
2 anode active material layer
3 electrolyte layer
4 cathode current collector
5 anode current collector
10 battery

What is claimed is:

1. A solid electrolyte, wherein a breaking energy in a filling rate of 100% is more than 21.4*10³ kJ/m³, when formed into a pellet having a length of 5 mm in an X axis direction, a length of 20 mm in a Y axis direction, and a length of 1 mm in a Z axis direction.

2. The solid electrolyte according to claim 1, wherein the breaking energy is 34.2*10³ kJ/m³ or more.

3. The solid electrolyte according to claim 1, wherein the breaking energy is 75.0*10³ kJ/m³ or less.

4. The solid electrolyte according to claim 1, wherein the solid electrolyte is a sulfide solid electrolyte.

5. The solid electrolyte according to claim 4, wherein the sulfide solid electrolyte contains a Li element, an A element (A is at least one kind of P, As, Sb, Si, Ge, Sn, B, Al, Ga, and In), and a S element.

6. The solid electrolyte according to claim 4, wherein the sulfide solid electrolyte contains a Li element, a P element, and a S element.

7. An anode mixture comprising an anode active material and a solid electrolyte, wherein
the solid electrolyte is the solid electrolyte according to claim 1.

8. The anode mixture according to claim 7, wherein the anode active material is a Si-based active material.

9. A battery comprising a cathode active material layer, an anode active material layer, and an electrolyte layer arranged between the cathode active material layer and the anode active material layer, wherein
at least one of the cathode active material layer, the anode active material layer, and the electrolyte layer contains the solid electrolyte according to claim 1.

10. A method for producing a battery including a cathode active material layer, an anode active material layer, and an electrolyte layer arranged between the cathode active material layer and the anode active material layer, the method comprising:
an anode active material layer forming step of forming the anode active material layer using an anode mixture containing an anode active material and an electrolyte, wherein
the electrolyte is the solid electrolyte according to claim 1.
